(19) United States
(12) Patent Application Publication
(10) Pub. No.: US 2016/0084937 A1
(43) Pub. Date: Mar. 24, 2016

(54) SYSTEMS AND METHODS FOR DETERMINING POSITION INFORMATION USING ACOUSTIC SENSING

(71) Applicant: Invensense Inc., San Jose, CA (US)

(72) Inventor: Shang-Hung Lin, San Jose, CA (US)

(21) Appl. No.: 14/493,232

(22) Filed: Sep. 22, 2014

(51) Int. Cl. G01S 5/20; G01S 5/22

(52) U.S. Cl. CPC G01S 5/20; G01S 5/22

(57) ABSTRACT

Systems and methods are disclosed for determining position information for a mobile device by combining motion sensor data with acoustic sensor data.

### FIELD OF THE PRESENT DISCLOSURE

This disclosure generally relates to techniques for determining the position of a mobile device and more particularly to position determinations using acoustic sensing.

### BACKGROUND

Particularly in the context of mobile devices, it is desirable to have information regarding the device's position or orientation. For example, movement detection of a device may be translated into navigation information using dead reckoning techniques. Further, information about the orientation of a device and/or its position with respect to other objects or common frames of reference may be exploited to provide gesture recognition. Many other applications can be enhanced by having accurate position information for a mobile device.

In many situations, position information for a mobile device may be obtained using on-board motion sensors. For example, a current orientation for the device may be determined by integrating gyroscopic sensor data. Using the determined device orientation, accelerometer sensor data may be converted from a body frame of reference to an external frame and doubly integrated to determine translational changes in position. Although effective, such techniques are hampered by drift or bias in the motion sensors. These errors may compound over time, leading to position information that suffers from increasing uncertainty. As will be appreciated, it would be desirable to help compensate for this characteristic.

In addition to motion sensors, developments in technology have led to the incorporation of an increasing variety of sensors in mobile devices. For example, a device may be equipped with one or more microphones or other acoustic sensors. As such, it would be desirable to combine the ability to sense sound sources in proximity to the device with motion sensor data to provide a more accurate determination of position information for the device or a sound source. This disclosure satisfies these and other needs as described in the following materials.

### SUMMARY

As will be described in detail below, this disclosure includes a method for determining position information for a mobile device involving determining a position of the mobile device in relation to at least a first sound source with a motion sensing block, determining a confidence level associated with position determined with the motion sensing block, determining a position of the mobile device in relation to the first sound source with an acoustic sensing block, determining a confidence level associated with position determined with the acoustic sensing block and combining the position determined with the motion sensing block and the position determined with the acoustic sensing block by weighting each determination using each respective confidence level.

In one aspect, combining the position determined with the motion sensing block and the position determined with the acoustic sensing block may be a sensor fusion operation. Further, the confidence level for each position determination may be derived from a probability density function associated with the position determinations.

In one aspect, position information for the mobile device may be determined independently of the first sound source. Additionally, a position of the first sound source may be determined in relation to the independently determined position.

In one aspect, a suitable method may further involve determining a position of the mobile device in relation to multiple sound sources with the motion sensing block, determining a position of the mobile device in relation to the multiple sound sources with the acoustic sensing block and combining the position determined with the motion sensing block and the position determined with the acoustic sensing block.

In one aspect, determining a position of the mobile device with the acoustic sensing block may include determining the incoming angle from the first source. The incoming angle may be derived from time of arrival calculations using a microphone array. Alternatively or in addition, the incoming angle may be derived from phase difference calculations. Using a single microphone, the change in incoming angle may be derived from a direction dependent transfer function.

In one aspect, determining a position of the mobile device with the acoustic sensing block may include estimating a distance to the first sound source. The distance may be estimated using sound power levels and/or using a Doppler effect.

In one aspect, the method may also include performing a calibration of the motion sensing block when the position determined with the motion sensing block indicates a change in position and when the position determined with the acoustic sensing block does not indicate a change in position.

In one aspect, the acoustic sensing block may be microphone array having an inter microphone distance and an increased effective inter microphone distance may be provided using a change in position indicated by the position determined with the motion sensing block.

In one aspect, the first sound source may be classified to determine whether the first sound source has a fixed location and the confidence level may be adjusted using the determination.

In one aspect, sound may be generated at the first sound source to facilitate sensing with the mobile device.

In one aspect, combining the position determined with the motion sensing block and the position determined with the acoustic sensing block may include performing a Bayesian inference.

This disclosure also includes a mobile device for determining position in relation to a sound source, wherein the device has a motion sensing block configured to determine a position of the mobile device in relation to at least a first sound source, an acoustic sensing block configured to determine a position of the mobile device in relation to the first sound source and a sensor fusion block configured to determine a confidence level associated with position determined with the motion sensing block, determine a confidence level associated with position determined with the acoustic sensing block and combine the position determined with the motion sensing block and the position determined with the acoustic sensing block by weighting each determination using each respective confidence level. The sensor fusion block may determine the confidence level for each position determination by deriving a probability density function associated with the position determinations.

In one aspect, the device may include a location manager configured to determine position information for the device independently of the first sound source. Further, the sound fusion block may determine a position for the first sound source in relation to the independently determined position information.

In one aspect, the acoustic sensing block may determine an incoming angle from the first sound source. The device may have a microphone array such that the incoming angle is derived from time of arrival calculations and/or from phase difference calculations. Incoming angle may also be derived from sound power levels detected by the acoustic sensing block. The device may have a single microphone and may derive the incoming angle from a direction dependent transfer function.

In one aspect, acoustic sensing block of the device may be configured to a position of the mobile device by estimating a distance to the first sound source. The distance may be estimated using sound power levels and/or using a Doppler effect.

In one aspect, the device may also include a calibration manager that performs calibration of at least one motion sensor when the position determined with the motion sensing block indicates a change in position and when the position determined with the acoustic sensing block does not indicate a change in position.

In one aspect, the device may have a microphone array with an inter microphone distance such that the acoustic sensing block may increase an effective inter microphone distance using a change in position indicated by the position determined with the motion sensing block.

In one aspect, the sound fusion block may also classify the first sound source to determine whether the first sound source has a fixed location and may adjust the confidence level using the determination.

In one aspect, the sound fusion block may combine the position determined with the motion sensing block and the position determined with the acoustic sensing block by performing a Bayesian inference.

### BRIEF DESCRIPTION OF THE DRAWINGS

FIGS. 1 and 2 are schematic diagrams showing determination of position information for a device in relation to a sound source according to an embodiment.

FIG. 3 schematically illustrates combining position information determined using acoustic sensing according to an embodiment.

FIG. 4 schematically illustrates an increase in effective sampling rate for an acoustic sensor according to an embodiment.

FIG. 5 is a schematic diagram of a device for determining position information in relation to a sound source according to an embodiment.

FIG. 6 is a flow chart of a routine for determining position information in relation to a sound source according to an embodiment.

### DETAILED DESCRIPTION

At the outset, it is to be understood that this disclosure is not limited to particularly exemplified materials, architectures, routines, methods or structures as such may vary. Thus, although a number of such options, similar or equivalent to those described herein, can be used in the practice or embodiments of this disclosure, the preferred materials and methods are described herein.

It is also to be understood that the terminology used herein is for the purpose of describing particular embodiments of this disclosure only and is not intended to be limiting.

The detailed description set forth below in connection with the appended drawings is intended as a description of exemplary embodiments of the present disclosure and is not intended to represent the only exemplary embodiments in which the present disclosure can be practiced. The term “exemplary” used throughout this description means “serving as an example, instance, or illustration,” and should not necessarily be construed as preferred or advantageous over other exemplary embodiments. The detailed description includes specific details for the purpose of providing a thorough understanding of the exemplary embodiments of the specification. It will be apparent to those skilled in the art that the exemplary embodiments of the specification may be practiced without these specific details. In some instances, well known structures and devices are shown in block diagram form in order to avoid obscuring the novelty of the exemplary embodiments presented herein.

For purposes of convenience and clarity only, directional terms, such as top, bottom, left, right, up, down, over, above, below, beneath, rear, back, and front, may be used with respect to the accompanying drawings or chip embodiments. These and similar directional terms should not be construed to limit the scope of the disclosure in any manner.

In this specification and in the claims, it will be understood that when an element is referred to as being “connected to” or “coupled to” another element, it can be directly connected or coupled to the other element or intervening elements may be present. In contrast, when an element is referred to as being “directly connected to” or “directly coupled to” another element, there are no intervening elements present.

Some portions of the detailed descriptions which follow are presented in terms of procedures, logic blocks, processing and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments described herein may be discussed in the general context of processor-executable instructions residing on some form of non-transitory processor-readable medium, such as program blocks, executed by one or more computers or other devices. Generally, program blocks include routines, programs, objects, components, data structures, etc., that perform particular tasks or implement particular abstract data types. The functionality of the program blocks may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, blocks, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the exemplary wireless communications devices may include components other than those shown, including well-known components such as a processor, memory and the like.

The techniques described herein may be implemented in hardware, software, firmware, or any combination thereof, unless specifically described as being implemented in a specific manner. Any features described as blocks or components may also be implemented together in an integrated logic device or separately as discrete but interoperable logic devices. If implemented in software, the techniques may be realized at least in part by a non-transitory processor-readable storage medium comprising instructions that, when executed, performs one or more of the methods described above. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor. For example, a carrier wave may be employed to carry computer-readable electronic data such as those used in transmitting and receiving electronic mail or in accessing a network such as the Internet or a local area network (LAN). Of course, many modifications may be made to this configuration without departing from the scope or spirit of the claimed subject matter.

The various illustrative logical blocks, blocks, circuits and instructions described in connection with the embodiments disclosed herein may be executed by one or more processors, such as one or more motion processing units (MPUs), digital signal processors (DSPs), general purpose microprocessors, application specific integrated circuits (ASICs), application specific instruction set processors (ASIPs), field programmable gate arrays (FPGAs), or other equivalent integrated or discrete logic circuitry. The term “processor,” as used herein may refer to any of the foregoing structure or any other structure suitable for implementation of the techniques described herein. In addition, in some aspects, the functionality described herein may be provided within dedicated software blocks or hardware blocks configured as described herein. Also, the techniques could be fully implemented in one or more circuits or logic elements. A general purpose processor may be a microprocessor, but in the alternative, the processor may be any conventional processor, controller, microcontroller, or state machine. A processor may also be implemented as a combination of computing devices, e.g., a combination of an MPU and a microprocessor, a plurality of microprocessors, one or more microprocessors in conjunction with an MPU core, or any other such configuration.

Unless defined otherwise, all technical and scientific terms used herein have the same meaning as commonly understood by one having ordinary skill in the art to which the disclosure pertains.

Finally, as used in this specification and the appended claims, the singular forms “a, “an” and “the” include plural referents unless the content clearly dictates otherwise.

As noted, this disclosure provides techniques for combining motion sensor data with acoustic sensor data to enhance position information for a mobile device. As used herein, the term “position information” means any information concerning the absolute or relative location of the device and may further include absolute or relative movement and/or orientation of the device, such as heading information. Further, in that a relative determination may be made between the device and a sound source, position information may also include information regarding the location of the sound source.

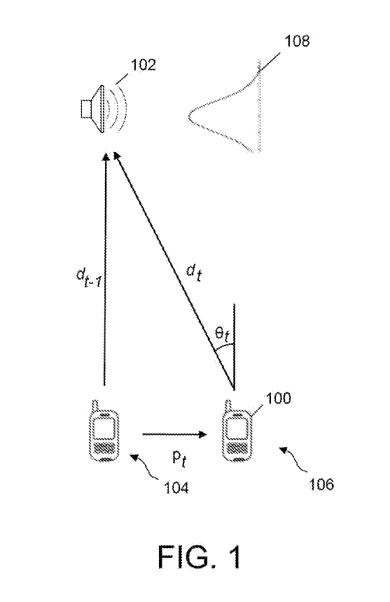

To help illustrate aspects of this disclosure, FIG. 1 schematically depicts the relative positioning of mobile device 100 and sound source 102. As shown, movement of device 100 pₜ is indicated by its position at time t−1 104 and at time t 106. Although this example is viewed in the context of device 100 moving relative to sound source 102, the following formulas and descriptions may be adapted as desired to represent movement of sound source 102 relative to device 100. Further, a single sound source is shown for clarity, but these techniques may be applied to any number of discrete sound sources. Each of multiple sound sources individually may be located, tracked and/or classified according to this disclosure. Device 100 may monitor an incoming angle θ to sound source 102 over time, as indicated at time t by θₜ. As will be appreciated, any suitable technique may be employed to determine the incoming angle. For example, if device 100 has a microphone array, differences in time of arrival or phase at each microphone may be used. For embodiments that have a single microphone, the sound power level or the direction dependent transfer function of an artificial pinna associated with the microphone may be used as desired. Any combination of these or other techniques may also be used. Further, device 100 may determine the distance d to sound source 102 at the respective times as indicated. Any suitable technique for estimating the distance may be used. For example, the distance may be determined by triangulation using the location and orientation change pₜ determined with motion sensor data and the angle change of the incoming sound. Alternatively or in addition, the sound power level, the Doppler effect, or any other suitable technique may also be used. A confidence level may be associated with the relative position determination regarding sound source 102. In one aspect, a probability density function p 108 representing sound source at time t may be determined according to Equation 1.

p(\hat{d}ₜ|\hat{p}ₜ,θₜ) (1)

FIG. 2 schematically represents further motion of device 100 pₜ₊₁ at time t+1 to position 110. The relative distance dₜ₊₁ and incoming angle θₜ₊₁ at this subsequent time may be determined as described above. Due to bias and/or drift in the motion sensors, a position determination for device 100 relying solely on motion sensor data may become increasingly uncertain over time. For example, a confidence level in the form of probability density function p 112 representing sound source at time t+1 may be determined according to Equation 2 using only motion sensor data, wherein a represents accelerometer output.

p(\hat{p}ₜ₊₁|\hat{p}ₜ,aₜ₊₁) (2)

As shown, probability density function p 112 may have substantial spread representing a lower concentration of probability for any given position, which reflects this growing uncertainty. To enhance this position determination, position information relative to sound source 102, such as distance and/or incoming angle, may be combined the motion sensor data to improve the position determination. A confidence level in the form of probability density function p 114 representing sound source at time t+1 may be determined according to Equation 3 using motion sensor data in combination with the position information relative to sound source 102, resulting in a more concentrated probability of position.

p(\hat{p}ₜ₊₁|\hat{d}ₜ,\hat{p}ₜ,\hat{θ}ₜ₊₁,aₜ₊₁) (3)

In one aspect, the more concentrated probability density function represents an improvement in the accuracy of the motion sensor data and may be used to enhance the performance of any application employing the motion sensor data. For example, dead reckoning navigational techniques may be improved by reducing the effect of sensor drift and bias. As another example, determining an accurate position for sound source 102 relative to device 100 may facilitate beamforming applications, such as for gaming or other similar uses.

As noted above, the acoustic sensing techniques of this disclosure may be applied to determine position information of mobile device 100 relative to one or more sound sources, such as sound source 102. Accordingly, it may be desirable to determine characteristics of sound source 102 in order to enhance the position determination. For example, sound recognition algorithms or other techniques may be applied to classify whether sound source 102 is likely to have a fixed location, such as a television or the like. A sound source with a fixed location may be used to increase the confidence given to the position determinations made for device 100 relative to that source. Consequently, calibration routines or other error handling mechanisms may be triggered more readily when it may be assumed that the reference position of sound source 102 is fixed. In another aspect, sound source 102 may be configured to generate a sound that facilitates one or more aspects of this disclosure. For example, if the generated sound has known characteristics, it may be identified an isolated more easily, or it may be tailored to have repetition, frequency and/or timing attributes that facilitate the position determinations.

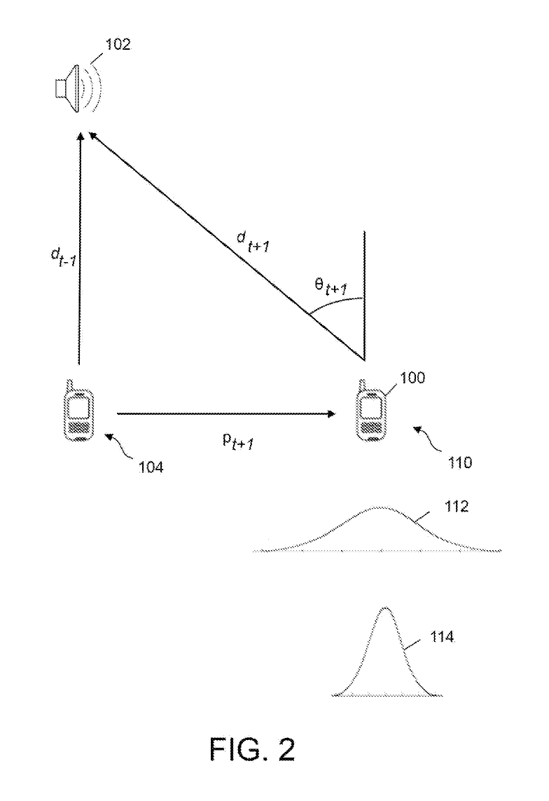

In one aspect, the correction of position determination obtained using motion sensor data with the position information relative to sound source 102 may be performed iteratively. For example, Bayesian inference methods may be used as schematically indicated in FIG. 3. As shown, device 100 may have an inertial motion unit (IMU) 120, which may include motion sensors such as a 3-axis gyroscope and a 3-axis accelerometer. An error estimator in the form of extended Kalman filter 122 may receive inputs from a variety of sources to determine bias, drift or other compensations that may be applied to the motion sensor data. In one aspect, Kalman filter 122 receives acoustic sensor data 124 to determine position information relative to one or more sound sources as described above. IMU 120 may output raw accelerometer data a^{b} which may be corrected by an error δa^{b} as determined by Kalman filter 122 and applied in summation block 126. Likewise, IMU 120 may output raw gyroscope data ω^{b} which may be corrected by an error δω^{b} applied in summation block 128. Further, Kalman filter 122 may be configured to determine a heading error φ, such as from magnetometer data 130. The corrected angular rate data from summation block 128 may be combined with the heading error to determine an orientation for device 100 in attitude update block 132. Thus, the rotational orientation of device 100 may be expressed relative to an external frame of reference as indicated by c_{b}ⁿ and output as R 134. The orientation of device 100 is also fed to coordinate conversion block 136 to convert the corrected accelerometer data from a body frame to the external frame, output as aⁿ. Acceleration due to the Earth's gravity may be subtracted from the accelerometer data in summation block 138. A first integration block 140 converts the accelerometer data to velocity vⁿ, which may be corrected by any velocity error δv^{b} output by Kalman filter 122 in summation block 142. Finally, a second integration block 144 converts the velocity to distance rⁿ, which may be corrected by any distance error δr^{b} output by Kalman filter 122 in summation block 146 to yield the translational distance determination T 148. Other suitable Bayesian inference techniques may also be applied, including embodiments implementing a particle filter, a Gaussian mixture filter, or the like.

In addition to enhancing position information, acoustic sensor data may also be used to facilitate calibration of one or more sensors of device 100. For example, if no change is detected for incoming angle θ or distance d, such as when the same power level of the incoming sound is detected, any motion sensor data corresponding to increasing or accelerating changes in the location of device 100 may be an indication of non-zero accelerometer bias. Accordingly, it may be desirable to trigger a calibration routine or other error handling procedure as a result. Similarly, these techniques may be applied to determine the likely existence of gyroscope bias by determining whether a discrepancy exists between incoming angle θ and the orientation of device 100 as determined using the gyroscope data. Still further, position information determined using acoustic sensor data 124 may help identify perturbations in other sensors. For example, magnetometer data that is affected by a magnetic anomaly or other interference may be identified when the magnetometer indicates a change in heading but acoustic sensor data 124 indicates device 100 has not changed orientation with respect to sound source 102.

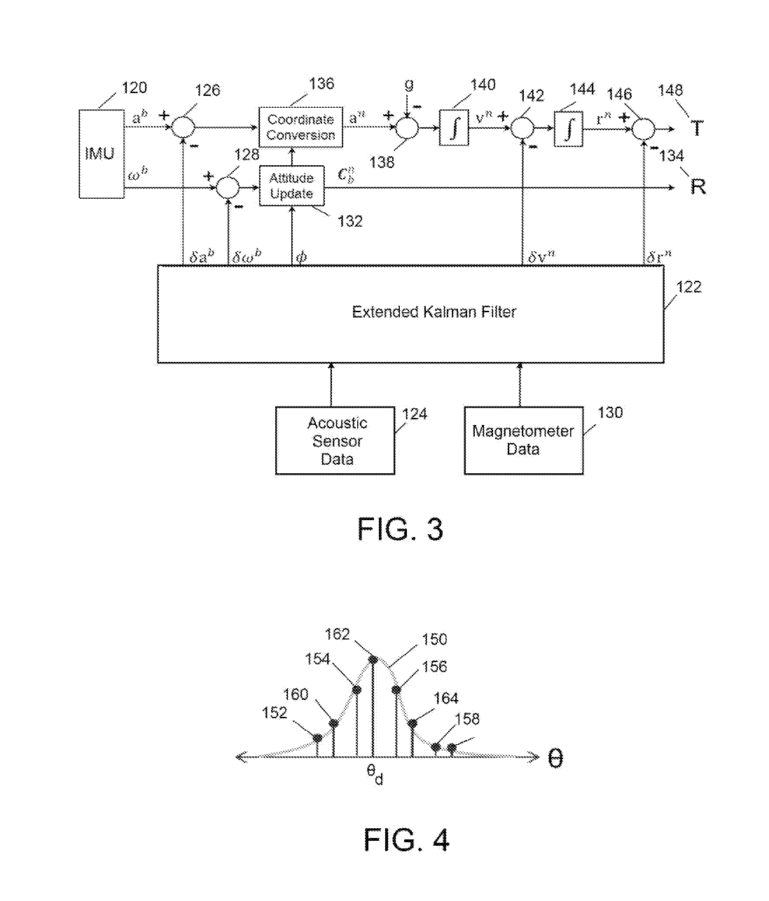

In another aspect, motion sensor data may be combined with acoustic sensor data to improve a confidence level associated with position information determined relative to a sound source. As known to those of skill in the art, algorithms for providing sound localization include Generalized Cross Correlation with Phase Transform (GCC-PHAT) and Steered Response Power using Phase Transform (SRP-PHAT). A schematic example of these techniques is depicted in FIG. 4. As shown, the angle of incoming sound θ may be determined by the time delay ζ between two microphones having an inter microphone distance d and a signal sampling frequency fs by using Equation 4, wherein C is the speed of sound.

$$θ = {sin}^{- 1} [ \frac{ζ * C}{{f}_{s} * d} ] \qquad ( 4 )$$

Sound localization algorithms have primarily been developed for stationary microphones. As such, difficulties may arise when applied to a mobile device, such as device 100. By using data from the motion sensors, compensation for any detected motion may be used to improve the position determination for the sound source.

Further, as indicated by Equation 4, the resolution with which 0 is determined may be limited by the inter microphone distance and the sample rate. Particularly for mobile devices having a smaller form factor, the maximum available inter microphone distance may be significantly constrained. As an example, if the inter microphone distance is 10 cm and sampling frequency is 16 KHz, there are only 9 different time delay samples, so that 0 may be determined with a resolution of 180/9=20 degrees. This effect is schematically illustrated in FIG. 4, which shows the cross correlation function curve 150 which, when maximized, provides a solution for incoming angle θ. A reduced set of sample points 152, 154, 156 and 158 may be available depending upon the inter microphone distance and the sample frequency, as described above. If the sample points do not align with the true maxima of the cross correlation function, the estimate of θ may not be as accurate as desired. In this example, sample point 154 or 156 may be selected as the maxima. However, movement of device 100 may be used to effectively increase the inter microphone distance. The motion may be either deliberate or incidental, and in some embodiments, may be prompted by device 100. By accurately tracking motion of device 100 using the motion sensors, additional sample points 160, 162, 164 and 166 may be generated. As a result, sample point 162 may be closer the true maxima of the cross correlation function, allowing for the determination of a more accurate θ_{d} as shown.

One embodiment of using the angle of incoming sound to determine the device orientation is as follows. Suppose h_{ref} is the 3D vector pointing to the incoming sound in world frame when the sound is first detected (i.e., time=0), θ_{ref} is the azimuth angle that h_{ref} projects onto the world XY plane, and σ is the uncertainty of the direction estimate (e.g. standard deviation of the probability density function). Assume that the sound source is stationary. At time t, the device orientation changes and its rotation matrix becomes R(t), and the direction of the same sound source at time t is measured as h_{b}(t) in body frame. Since the sound source is stationary, the world frame representation of h_{b}(t) should be very similar to h_{ref}:

h_{w}(t)=R(t)h_{b}(t)≈h_{ref} (5)

The difference between h_{ref} and h_{w}(t) may come from the uncertainty of the incoming sound direction detection or the estimation error of device orientation in R(t). Suppose θ(t) is the azimuth angle that h(t) projects onto the world XY plane. The following equations may be used to update the rotation matrix R:

$$\begin{matrix}Δθ ( t ) = θ ( t ) - {θ}_{ref} & ( 6 ) \\ G = \frac{P ( t )}{P ( t ) + {Δθ ( t )}^{2}} & ( 7 ) \\ P ( t + 1 ) = ( 1 - G ) P ( t ) + {σ}^{2} & ( 8 ) \\ R ( t + 1 ) = R ( t ) R ( z ; α G Δθ ( t ) ) & ( 9 )\end{matrix}$$

R(z; αGΔθ(t)) represents the rotation with angle of αGΔθ(t) along the z axis (α is a tuning parameter; |α|≦1).

Details regarding one embodiment of a mobile electronic device 100 configured to determine position information using acoustic sensing according to this disclosure are depicted as high level schematic blocks in FIG. 2. As will be appreciated, device 100 may be implemented as a device or apparatus, such as a handheld device that can be moved in space by a user and its motion and/or orientation in space therefore sensed. For example, such a handheld device may be a mobile phone (e.g., cellular phone, a phone running on a local network, or any other telephone handset), tablet, wearable device, including a health and fitness band, glasses, or the like, personal digital assistant (PDA), video game player, video game controller, navigation device, mobile internet device (MID), personal navigation device (PND), digital still camera, digital video camera, binoculars, telephoto lens, portable music, video, or media player, remote control, or other handheld device, or a combination of one or more of these devices.

As desired, device 100 may be self-contained device or may function in conjunction with another portable device or a non-portable device such as a desktop computer, electronic tabletop device, server computer, etc. which can communicate with the device 100, e.g., via network connections. The device may be capable of communicating via a wired connection using any type of wire-based communication protocol (e.g., serial transmissions, parallel transmissions, packet-based data communications), wireless connection (e.g., electromagnetic radiation, infrared radiation or other wireless technology), or a combination of one or more wired connections and one or more wireless connections. Therefore, although the primary embodiments discussed in this disclosure are in the context of a self-contained device, any of the functions described as being performed by device 100 may be implemented in a plurality of devices as desired and depending on the relative capabilities of the respective devices. As an example, a wearable device may have one or more sensors that output data to another device, such as a smart phone or tablet, which may be used to perform any or all of the other functions. As such, the term “device” may include either a self-contained device or a combination of devices acting in concert.

As shown, device 100 includes MPU 170, host processor 172, host memory 174, and may include one or more sensors, such as acoustic sensor 176, configured as an external sensor. Depending on the embodiment, acoustic sensor 176 may be implemented as a single microphone or an array of two or more microphones or other devices configured to measure sound waves. Host processor 172 may be configured to perform the various computations and operations involved with the general function of device 100. Host processor 172 may be coupled to MPU 170 through bus 178, which may be any suitable bus or interface, such as a peripheral component interconnect express (PCIe) bus, a universal serial bus (USB), a universal asynchronous receiver/transmitter (UART) serial bus, a suitable advanced microcontroller bus architecture (AMBA) interface, an Inter-Integrated Circuit (I2C) bus, a serial digital input output (SDIO) bus, or other equivalent. Host memory 174 may include programs, drivers or other data that utilize information provided by MPU 170. Exemplary details regarding suitable configurations of host processor 172 and MPU 170 may be found in co-pending, commonly owned U.S. patent application Ser. No. 12/106,921, filed Apr. 21, 2008, which is hereby incorporated by reference in its entirety.

In this embodiment, MPU 170 is shown to include sensor processor 180, memory 182 and internal sensor 184. Memory 182 may store algorithms, routines or other instructions for processing data output by internal sensor 184. One or more additional internal sensors may be integrated into MPU 170 as desired. For example, internal sensor 184 may include a gyroscope, such as a 3-axis gyroscope, and an accelerometer, such as a 3-axis accelerometer, allowing MPU 170 to function as IMU 120 as described above in conjunction with FIG. 3. As used herein, the term “internal sensor” refers to a sensor implemented using the MEMS techniques described above for integration with MPU 170 into a single chip. Similarly, an “external sensor” as used herein refers to a sensor carried on-board device 100 that is not integrated into MPU 170. Although this embodiment is described as featuring motion sensors implemented as internal sensor 184 and acoustic sensor 176 implemented as an external sensor, any combination of internal and/or external sensors may be used. Further, additional sensors of the same type or different may be provided either as internal or external sensors as desired. Examples of suitable sensors include accelerometers, gyroscopes, magnetometers, pressure sensors, hygrometers, barometers, microphones, photo sensors, cameras, proximity sensors and temperature sensors among others.

As will be appreciated, host processor 172 and/or sensor processor 180 may be one or more microprocessors, central processing units (CPUs), or other processors which run software programs for device 100 or for other applications related to the functionality of device 100. For example, different software application programs such as menu navigation software, games, camera function control, navigation software, and phone or a wide variety of other software and functional interfaces can be provided. In some embodiments, multiple different applications can be provided on a single device 100, and in some of those embodiments, multiple applications can run simultaneously on the device 100. Multiple layers of software can be provided on a computer readable medium such as electronic memory or other storage medium such as hard disk, optical disk, flash drive, etc., for use with host processor 172 and sensor processor 180. For example, an operating system layer can be provided for device 100 to control and manage system resources in real time, enable functions of application software and other layers, and interface application programs with other software and functions of device 100. In some embodiments, one or more motion algorithm layers may provide motion algorithms for lower-level processing of raw sensor data provided from internal or external sensors. Further, a sensor device driver layer may provide a software interface to the hardware sensors of device 100. Some or all of these layers can be provided in host memory 174 for access by host processor 172, in memory 182 for access by sensor processor 180, or in any other suitable architecture.

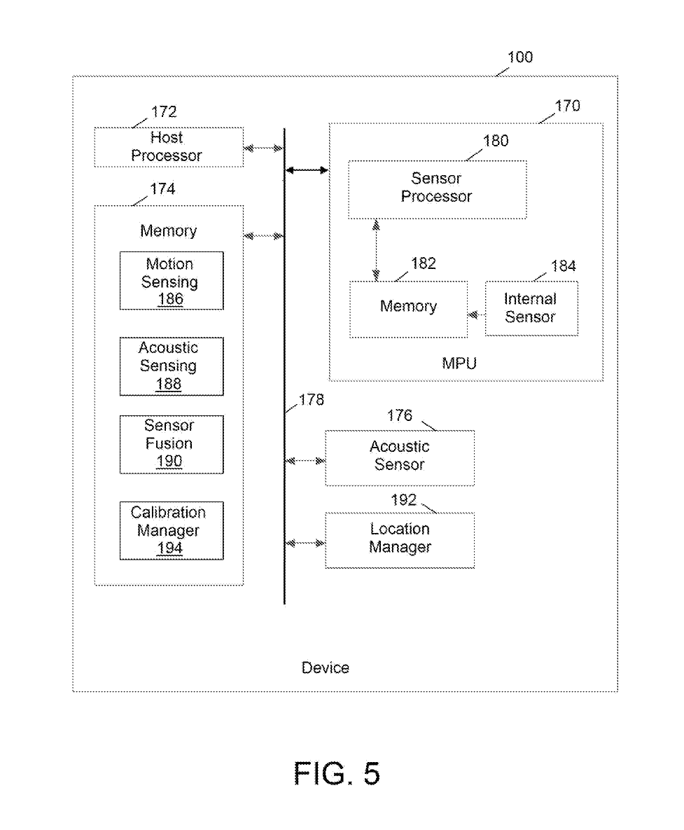

In the embodiment depicted in FIG. 5, device 100 may implement functional blocks configured to perform operations associated with the techniques of this disclosure. For example, host memory 174 may include motion sensing block 186 receiving motion sensor data, such as gyroscope and accelerometer data from internal sensor 184 processed by sensor processor 180 to determine a position of the device 100 in relation to one or more sound sources, such as sound source 102. Host member 174 may also include acoustic sensing block 188 receiving acoustic sensor data, such as from acoustic sensor 176 to determine a position of device 100 in relation to the one or more sound sources. Further, host member 174 may include sensor fusion block 190 to determine confidence levels associated with the positions determined by motion sensing block 186 and acoustic sensing block 188 and provide a combined position determination by weighting each determination using each respective confidence level. As described above, sound fusion block 190 may determine confidence levels by calculating probability density functions associated with the position determinations in some embodiments. As will be appreciated, motion sensing block 186, acoustic sensing block 188 and sensor fusion block 190 may cooperate to perform some or all of the operation described with respect to FIG. 3 to combine the position determinations using suitable Bayesian interference methods.

In some embodiments, device 100 may have position determination capabilities that may function without reliance on the acoustic sensor data. For example, device 100 may feature location manager 192 configured to provide a location determination for device 100. As will be appreciated, location manager 192 may employ any technique for determining location, including a Global Navigation Satellite System (GNSS), such as GPS, GLONASS, Galileo and Beidou, WiFi positioning, cellular tower positioning, Bluetooth™ positioning beacons, dead reckoning or any other similar method. Thus, in some embodiments, device 100 may use position information from location manager 192 to determine position information for sound source 102 in a frame of reference that is independent of device 100, such as a geographic location or other external reference. Still further, the position information determinations made using acoustic sensor data according to the techniques of this disclosure may be used to augment the information obtained by location manager 192. For example, due to poor satellite visibility, GNSS performance may be degraded indoors or in other situations in which line of sight to a sufficient number of satellites is compromised. In such situations, greater reliance may be placed on the position information determined with acoustic sensor data.

As desired, device 100 may also include calibration manager 194, shown in this embodiment as being implemented in host memory 174. Calibration manager 194 may be configured to compare position information obtained from acoustic sensing block 188 to position information from motion sensing block 186 to determine whether motion sensor data may be degraded by bias or drift in the manner described above. Alternatively or in addition, calibration manager 194 may be configured to perform a calibration routine for one or more motion sensors using position information for sound source 102 as a reference.

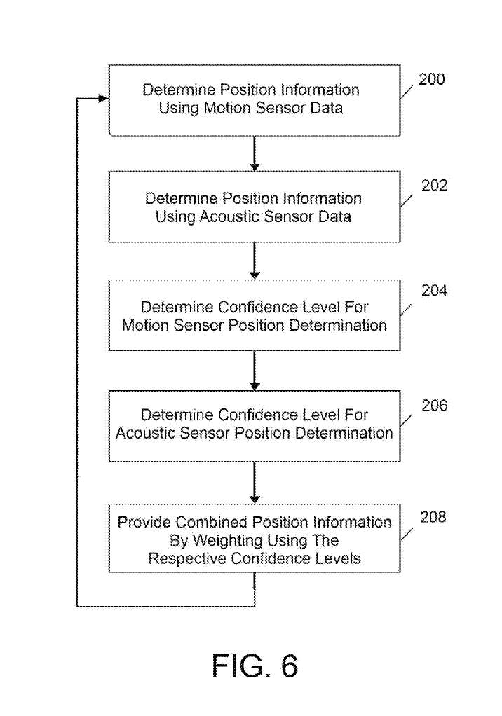

Further, as one of skill in the art will appreciate, any of the functional operations described above may be performed by any combination of hardware, firmware and software. Accordingly, aspects of this disclosure may be illustrated in reference to the flowchart shown in FIG. 6, which represents an exemplary routine for determining position information for device 100. Beginning in 200, motion sensing block 186 may determine a position of device 100 in relation to sound source 102. In 202, acoustic sensing block 188 may determine a position of device 100 in relation to sound source 102. Next, sensor fusion block 190 may combine the position determinations by determining a confidence level associated with the position determined by motion sensing block 186 in 204 and determining a confidence level associated with the position determined by acoustic sensing block 188 in 206. Sensor fusion block 190 may then provide a combined position obtained by weighting each determination using the respective confidence levels in 208. This sequence of operations may be performed recursively as updated position determination from motion sensing block 186 and acoustic sensing block 188 become available as indicated by the routine looping back to 200 as shown.

In the described embodiments, a chip is defined to include at least one substrate typically formed from a semiconductor material. A single chip may be formed from multiple substrates, where the substrates are mechanically bonded to preserve the functionality. A multiple chip includes at least two substrates, wherein the two substrates are electrically connected, but do not require mechanical bonding. A package provides electrical connection between the bond pads on the chip to a metal lead that can be soldered to a PCB. A package typically comprises a substrate and a cover. Integrated Circuit (IC) substrate may refer to a silicon substrate with electrical circuits, typically CMOS circuits. MEMS cap provides mechanical support for the MEMS structure. The MEMS structural layer is attached to the MEMS cap. The MEMS cap is also referred to as handle substrate or handle wafer. In the described embodiments, an electronic device incorporating a sensor may employ a motion tracking block also referred to as Motion Processing Unit (MPU) that includes at least one sensor in addition to electronic circuits. The sensor, such as a gyroscope, a compass, a magnetometer, an accelerometer, a microphone, a pressure sensor, a proximity sensor, or an ambient light sensor, among others known in the art, are contemplated. Some embodiments include accelerometer, gyroscope, and magnetometer, which each provide a measurement along three axes that are orthogonal relative to each other referred to as a 9-axis device. Other embodiments may not include all the sensors or may provide measurements along one or more axes. The sensors may be formed on a first substrate. Other embodiments may include solid-state sensors or any other type of sensors. The electronic circuits in the MPU receive measurement outputs from the one or more sensors. In some embodiments, the electronic circuits process the sensor data. The electronic circuits may be implemented on a second silicon substrate. In some embodiments, the first substrate may be vertically stacked, attached and electrically connected to the second substrate in a single semiconductor chip, while in other embodiments, the first substrate may be disposed laterally and electrically connected to the second substrate in a single semiconductor package.

In one embodiment, the first substrate is attached to the second substrate through wafer bonding, as described in commonly owned U.S. Pat. No. 7,104,129, which is incorporated herein by reference in its entirety, to simultaneously provide electrical connections and hermetically seal the MEMS devices. This fabrication technique advantageously enables technology that allows for the design and manufacture of high performance, multi-axis, inertial sensors in a very small and economical package. Integration at the wafer-level minimizes parasitic capacitances, allowing for improved signal-to-noise relative to a discrete solution. Such integration at the wafer-level also enables the incorporation of a rich feature set which minimizes the need for external amplification.

In the described embodiments, raw data refers to measurement outputs from the sensors which are not yet processed. Motion data refers to processed raw data. Processing may include applying a sensor fusion algorithm or applying any other algorithm. In the case of a sensor fusion algorithm, data from one or more sensors may be combined to provide an orientation of the device. For example, data from a 3-axis gyroscope and a 3-axis accelerometer may be combined in a 6-axis sensor fusion and data from a 3-axis gyroscope, a 3-axis accelerometer and a 3-axis magnetometer may be combined in a 9-axis sensor fusion. In the described embodiments, an MPU may include processors, memory, control logic and sensors among structures.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the present invention.

What is claimed is:

1. A method for determining position information for a mobile device comprising:
determining a position of the mobile device in relation to at least a first sound source with a motion sensing block;
determining a confidence level associated with position determined with the motion sensing block;
determining a position of the mobile device in relation to the first sound source with an acoustic sensing block;
determining a confidence level associated with position determined with the acoustic sensing block; and
combining the position determined with the motion sensing block and the position determined with the acoustic sensing block by weighting each determination using each respective confidence level.

2. The method of claim 1, wherein combining the position determined with the motion sensing block and the position determined with the acoustic sensing block comprises a sensor fusion operation.

3. The method of claim 1, wherein the confidence level for each position determination is derived from a probability density function associated with the position determinations.

4. The method of claim 1, further comprising determining position information for the mobile device independently of the first sound source.

5. The method of claim 4, further comprising determining a position of the first sound source in relation to the independently determined position.

6. The method of claim 1, further comprising:
determining a position of the mobile device in relation to multiple sound sources with the motion sensing block;
determining a position of the mobile device in relation to the multiple sound sources with the acoustic sensing block; and
combining the position determined with the motion sensing block and the position determined with the acoustic sensing block.

7. The method of claim 1, wherein determining a position of the mobile device with the acoustic sensing block comprises determining an incoming angle from the first source.

8. The method of claim 7, wherein the acoustic sensing block comprises a microphone array and wherein determining the incoming angle is derived from time of arrival calculations.

9. The method of claim 7, wherein the acoustic sensing block comprises a microphone array and wherein determining in incoming angle is derived from phase difference calculations.

10. The method of claim 7, wherein determining the incoming angle is derived from sound power levels detected by the acoustic sensing block.

11. The method of claim 7, wherein the acoustic sensing block comprises a single microphone and wherein determining the incoming angle is derived from a direction dependent transfer function.

12. The method of claim 1, wherein determining a position of the mobile device with the acoustic sensing block comprises estimating a distance to the first sound source.

13. The method of claim 12, wherein the distance is estimated using sound power levels.

14. The method of claim 12, wherein the distance is estimated using a Doppler effect.

15. The method of claim 1, further comprising performing a calibration of the motion sensing block when the position determined with the motion sensing block indicates a change in position and when the position determined with the acoustic sensing block does not indicate a change in position.

16. The method of claim 1, wherein the acoustic sensing block comprises a microphone array having an inter microphone distance and further comprising providing an increased effective inter microphone distance using a change in position indicated by the position determined with the motion sensing block.

17. The method of claim 1, further comprising classifying the first sound source to determine whether the first sound source has a fixed location and adjusting the confidence level using the determination.

18. The method of claim 1, further comprising generating sound at the first sound source configured to facilitate sensing with the mobile device.

19. The method of claim 1, wherein combining the position determined with the motion sensing block and the position determined with the acoustic sensing block comprises performing a Bayesian inference.

20. A mobile device for determining position in relation to a sound source comprising:
a motion sensing block configured to determine a position of the mobile device in relation to at least a first sound source;
an acoustic sensing block configured to determine a position of the mobile device in relation to the first sound source; and
a sensor fusion block configured to:
determine a confidence level associated with position determined with the motion sensing block;
determine a confidence level associated with position determined with the acoustic sensing block; and
combine the position determined with the motion sensing block and the position determined with the acoustic sensing block by weighting each determination using each respective confidence level.

21. The device of claim 20, wherein the sensor fusion block determines the confidence level for each position determination by deriving a probability density function associated with the position determinations.

22. The device of claim 20, further comprising a location manager configured to determine position information for the device independently of the first sound source.

23. The device of claim 22, wherein the sound fusion block is further configured to determine a position for the first sound source in relation to the independently determined position information.

24. The device of claim 20, wherein the acoustic sensing block is configured to determine an incoming angle from the first sound source.

25. The device of claim 24, wherein the device further comprises a microphone array and wherein the acoustic sensing block derives the incoming angle from time of arrival calculations.

26. The device of claim 24, wherein the device further comprises a microphone array and wherein the acoustic sensing block derives the incoming angle from phase difference calculations.

27. The device of claim 24, wherein the acoustic sensing block derives the incoming angle from sound power levels detected by the acoustic sensing block.

28. The device of claim 24, wherein the device further comprises a single microphone and wherein the acoustic sensing block derives the incoming angle from a direction dependent transfer function.

29. The device of claim 20, wherein the acoustic sensing block determines a position of the mobile device by estimating a distance to the first sound source.

30. The device of claim 29, wherein the acoustic sensing block estimates distance using sound power levels.

31. The device of claim 29, wherein the acoustic sensing block estimates distance using a Doppler effect.

32. The device of claim 20, further comprising a calibration manager configured to perform calibration of at least one motion sensor when the position determined with the motion sensing block indicates a change in position and when the position determined with the acoustic sensing block does not indicate a change in position.

33. The device of claim 20, wherein the device further comprises a microphone array having an inter microphone distance and wherein the acoustic sensing block increases an effective inter microphone distance with a change in position indicated by the position determined with the motion sensing block.

34. The device of claim 20, wherein the sound fusion block is further configured to classify the first sound source to determine whether the first sound source has a fixed location and to adjust the confidence level using the determination.

35. The device of claim 20, wherein the sound fusion block combines the position determined with the motion sensing block and the position determined with the acoustic sensing block by performing a Bayesian inference.
